(19) United States
(12) Patent Application Publication
(10) Pub. No.: US 2011/0010210 A1
(43) Pub. Date: Jan. 13, 2011

(54) EDUCATIONAL ASSET DISTRIBUTION SYSTEM AND METHOD

(76) Inventors: Robert L. ALCORN, Arlington, VA (US); Deborah Everhart, Washington, DC (US); Ramsey R. Chambers, Reston, VA (US)

Correspondence Address: MCDERMOTT WILL & EMERY LLP, 600 13TH STREET, N.W., WASHINGTON, DC, 20005-3096, US

(21) Appl. No.: 12/500,844

(22) Filed: Jul. 10, 2009

(51) Int. Cl. G06Q 10/00; G06F 17/30; G06F 21/00; G06Q 50/00; G06Q 30/00

(52) U.S. Cl. 705/7; 726/3; 707/E17.044; 707/E17.107; 706/54; 707/603; 707/607

(57) ABSTRACT

An educational asset distribution system including an asset registration module which obtains information about a plurality of educational assets, said information including fixed metadata descriptive of an educational asset, and information for accessing the educational asset; a learning management system interface which receives context data descriptive of a user of a learning management system; a dynamic metadata storage which stores a portion of the context data in association with the fixed metadata; and an educational assets management module for managing the plurality of educational assets based on the context data, the information about the plurality of educational assets, and data stored in the dynamic metadata storage.

### BACKGROUND

1. Field

The present disclosure relates to the distribution of learning materials, and more particularly, to methods and systems for distributing educational assets such as digital learning assets.

2. Background

The use of textbooks and other printed matter as instructional materials is well known. Beyond merely serving as instructional materials, it has been common for a curriculum to be designed around a particular text, with material such as student exercises included in the instructional materials. This has occurred because suggested curricula often are part of the marketing of such materials, and also helps limit the number of texts that a student needs to obtain for a given course. Where shortcomings are perceived with a primary text for a course, it is common to supplement with individual articles or such.

In recent years, computers have become an integral part of education. Today, many institutions employ integrated learning systems to facilitate the use of computers in education, providing a portal to computer-based resources relating to, for example, courses a student is enrolled in. Such resources include course listings, coursework assignment distribution and submission, announcements, and community collaborative tools. As part of this trend, the use of textbooks and other such printed matter is increasingly being displaced by the use of digital learning assets. Traditional educational asset providers have followed this shift, and have begun migrating instructional materials online.

Such digital learning assets are presented on a computer display, in the form of text, video, etc., depending on the format in which the asset is provided and permissions afforded by an asset provider. Such digital learning assets may also be presented via interactive online learning tools.

In addition to traditional large publishers, there are other educational asset providers. Instructors, for example, were among some of the first to develop online educational resources. Also, the shift to computer-based educational assets has lowered the barriers to market for small providers. However, as the number of small producers of educational assets increases over time, it becomes more difficult to make consumers aware of individual assets, let alone distinguish more effective or useful assets over other assets.

Although large publishers generally enjoy an advantage in a conventional market, at least with respect to more popular products, there remain many missed opportunities. Large publishers also wish to sell more focused products. However, generally the costs of marketing to smaller markets outweighs the revenue to be obtained. Exceptions may occur with low-volume, high-price educational assets, but generally there is no successful path for selling low-volume, low-price educational assets at this time—for either large- or small-scale publishers.

Thus, for at least the reasons discussed above, there is a need to more successfully and inexpensively connect the producers of educational assets with instructors and students with an interest in purchasing or otherwise using those assets.

### SUMMARY

The present disclosure describes an educational asset distribution system including an asset registration module which obtains information about a plurality of educational assets, said information including fixed metadata descriptive of an educational asset, and information for accessing the educational asset; a learning management system interface which receives context data descriptive of a user of a learning management system; a dynamic metadata storage which stores a portion of the context data in association with the fixed metadata; and a recommender module which selects a plurality of recommended assets based on the context data, the information about a plurality of educational assets, and data stored in the dynamic metadata storage.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an exemplary educational asset distribution system (EADS) 110 and a number of entities that interoperate with it.

FIG. 2 is a screenshot of a learning management system (LMS) portal to EADS 110.

FIG. 3 is a screenshot of an LMS portal to EADS 110, displaying a user's personal asset collection.

FIG. 4 is a screenshot of an LMS portal to EADS 110, displaying an institutional asset collection.

FIG. 5 is a screenshot of an LMS portal to EADS 110, displaying details of an asset, including user reviews.

FIG. 6 is a simplified functional block diagram of a computer.

FIG. 7 is a simplified functional block diagram of a general-purpose computer system.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, and components have been described at a relatively high-level, without detail, in order to avoid unnecessarily obscuring aspects of the present teachings.

As education materials move from printed materials to computer-based learning systems, there are new opportunities to improve the results obtained from distribution for asset providers, educational institutions, instructors, and students.

Although asset providers have been able to deliver educational content for use in learning systems, it has been in the form of course packages, where an entire course of study is provided by an asset provider. Conventional learning systems do not offer a mechanism for instructors to piece together a course on a topic-by-topic basis with assets from a variety of sources, and they further do not allow students to discover additional supplemental content from within the learning system.

### The Educational Asset Distribution System

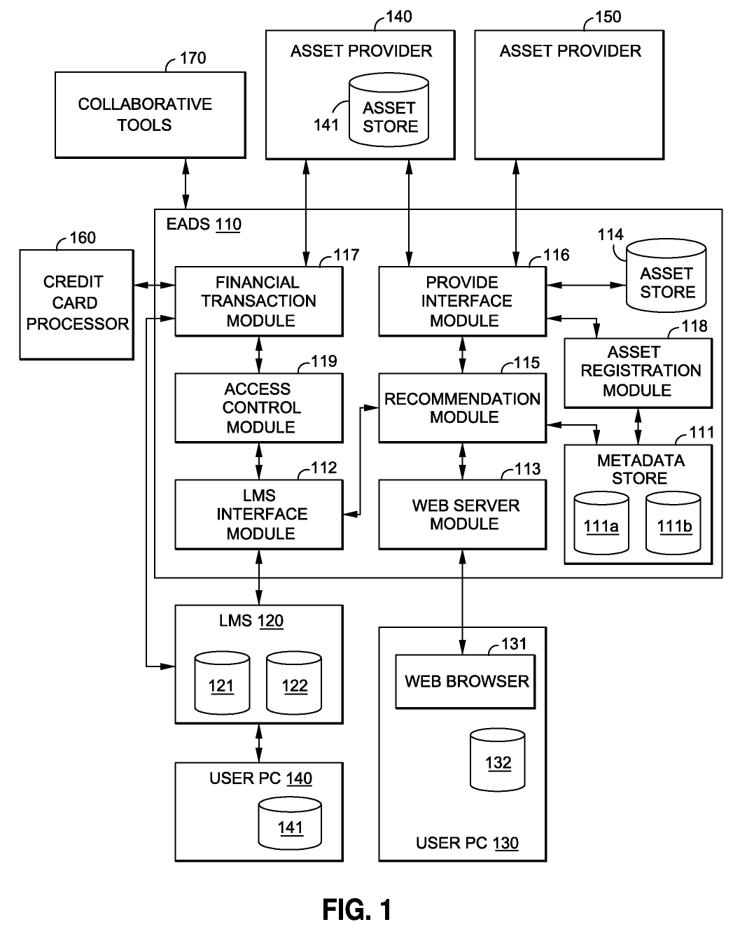

FIG. 1 illustrates a block diagram view of an embodiment of an educational asset distribution system (EADS) 110 for managing educational assets and a number of entities that interoperate with EADS 110. Various software layers or modules are shown within EADS 110. As is well known to one skilled in the art, these layers or modules are implemented in computer code to perform the functions described herein. It is noted that while EADS 110 is illustrated with the layers or modules shown in FIG. 1, various other hardware or software modules may exist within EADS 110 including, for example, a processor and storage means including instructions which cause the processor to be programmed and operate according to the methods and techniques described herein. Other entities illustrated in FIG. 1, such as learning management system (LMS) 120 and asset providers 140 and 150, may be similarly configured. Arrows are provided in FIG. 1 to illustrate particular relationships between modules and other entities. However, the illustrated relationships are not exhaustive or exclusive, but are merely illustrative of such relationships.

In a preferred embodiment, a single EADS 110 may be used to provide asset distribution and management for a plurality of educational institutions, each institution using one or more LMS systems to provide access to computer-based educational content to its students. In such an embodiment, benefits described herein are amplified by aggregating greater amounts of assets and associated metadata. However, other embodiments are contemplated, where, for example, an institution may operate a dedicated EADS 110. In such embodiments, EADS 110 and LMS 120 may be included within the same computer system, making common use of various resources such as processors, storage, and databases.

There are two main approaches, which may be used individually or in combination, to maintaining a library controlling the distribution of assets. The first is to create a repository in which assets are stored and accessed. According to the repository approach, the EADS 110 maintains a massive store of electronic assets, asset store 114. Content providers publish assets to the repository. For example, asset provider system 150 connects to EADS 110 via provider interface module 116, and then publishes assets to be made available via EADS 110, which are stored in asset store 114. Fixed metadata associated with each asset is also received via provider interface module 116, and asset registration module 118 stores the fixed metadata in fixed metadata store 111a included in metadata store 111. Fixed metadata may comprise information that provides simple identification of an asset, such as its title, or more extensive information may be provided, as discussed in more detail below.

The second approach is to create a directory, which interfaces with asset-provider managed repositories. According to the directory approach, the EADS 110 maintains a massive directory of assets, but does not store the assets themselves. Asset providers publish metadata about assets to the directory, including metadata providing access to actual content. For example, asset provider 140 maintains its assets in asset store 141, which is accessible via a data network, such as the Internet. Asset provider 140 connects to EADS 110 via provider interface module 116, and then registers assets for availability via EADS 110. Asset registration module 118 stores the registration data as fixed metadata in fixed metadata store 111a. The directory approach better supports assets hosted on a remote system, such as a remote website with specialized interactive content. As the directory merely links to such assets, asset providers are able to maintain control over the user experience, engage in more innovative approaches to educational content, and more freely update assets. In some embodiments of the directory approach, rather than the EADS 110 maintaining a local copy of fixed metadata for assets, a federated metadata storage is used, in which asset providers maintain their own directories of assets, against which the EADS 110 performs queries. In such embodiments, an asset provider 140 is registered with the EADS 110, but individual assets are not registered. In some embodiments, a hybrid directory approach may be employed, allowing asset providers flexibility in maintaining assets and registering assets with the EADS 110. In some embodiments, LMS 120 may operate as an asset provider, registering an asset with EADS 110 for global use by users on other LMS systems, or limited to users of the LMS 120 hosting the asset.

Additionally, there is a hybrid approach, where some assets are managed according to the repository approach, and other assets are managed according to the directory approach. The hybrid approach affords asset providers the greatest flexibility in supplying and presenting assets to users.

Asset registration module 118 not only records fixed metadata in fixed metadata storage 111a for non-federated repositories, as described above, but it also identifies available assets for other components of the EADS 110. For example, in an embodiment including an asset repository and a federated directory, asset registration module 118 obtains metadata from fixed metadata store 111a and interacts with asset provider directory systems to obtain federated asset metadata. Caching of metadata may be performed by the asset registration module 118 in order to enhance performance, which is helpful where federated directories are employed.

Regardless of which of the above approaches is applied for the asset library, for the plurality of assets which are managed and distributed by the EADS 110, the EADS 110 maintains fixed metadata, in fixed metadata store 111a, describing the assets. This fixed metadata, in conjunction with dynamic metadata stored in dynamic metadata store 111b, is used to search for assets corresponding to user needs. A number of vocabularies may be used by asset providers to describe the fixed metadata. For example, there are standard vocabularies, such as Dublin Core and IMS, for describing educational assets. Additionally, with the increasing importance of adhering to various learning standards, additional vocabularies have been created or may be developed to indicate the manner in which an asset is aligned with particular learning standards. Also, custom vocabularies may be agreed upon between the asset provider and the EADS 110, which convey asset information not captured by standard asset metadata vocabularies.

The primary user interface for a user, operating a user PC 140, is via LMS 120. The user is able to sign on into LMS 120, typically via a web browser session, and able to access course information for one or more courses accessible through LMS 120. U.S. Pat. No. 6,988,138, entitled “INTERNET-BASED EDUCATION SUPPORT SYSTEM AND METHODS,” which is incorporated by reference in its entirety, illustrates an LMS referred to as an “education support system 100.” LMS 120 interoperates with EADS 110 via LMS interface module 112, typically via a data network connection. LMS interface module 112 and LMS 120 are able to initiate transactions with one another for requesting and transferring data

Alternatively, a user, operating a user PC 130, may connect with a web browser 131 directly to EADS 110, via web server module 113. Web server 113 may perform authentication of the user in order to maintain persistent storage of user information, although users may be able to connect to EADS 110 via web server module without authentication for purposes such as browsing the assets made available by EADS 110.

EADS 110 includes a recommendation module 115 which identifies assets, based on metadata in metadata store 111, which appear to be relevant to a user's needs. The user's needs are determined by context data describing the user, and what the user is searching for. Examples of context data include role data, indicating, for example, if a user is an instructor or a student in a particular context; implicit search predicates; and implicit metadata contributions. This context data may be actively provided by the user, such as in the form of search terms or navigation actions through a catalog of available assets. Alternatively, LMS 120 may, without express action taken by the user, provide further context data, such as courses in which the user is enrolled, and attributes of those courses. In addition to simply receiving context data, recommendation module 115 may identify further context data of interest, and request the context data from the LMS 120. By such “pulling” of context data, the LMS 120 is not responsible for identifying relevant context data, but merely needs to be able to respond to requests by recommendation module 115 for context data. Recommendation module 115 employs a recommender system which operates in a manner familiar to commerce systems. Additionally, recommendation module 115 may rank the identified assets in order to more effectively present relevant choices to the user.

As discussed above, recommendation module 115 draws upon asset information in metadata store 111. In addition to fixed metadata store 111a which stores fixed metadata supplied by asset providers to identify and describe educational assets registered with the EADS 110, metadata store 111 further includes a dynamic metadata store 111b. Dynamic metadata store 111b stores dynamic metadata obtained by the EADS 110 accumulated the course of operation. Examples of dynamic metadata include, but are not limited to, search patterns of users in conjunction with the context in which they are searching via the EADS 110, tagging and categorization of assets by users of the EADS 110, outcome data describing user performance, community comments such as single- or multi-value ranking of assets and user comments about assets, and a user's prior purchases and use of assets. Use of such dynamic metadata by the recommendation module 115 provides a community-oriented approach to identifying assets relevant to a user's context. As the dynamic metadata store 111b accumulates information about assets reflecting their use across multiple users and institutions, it provides a rich view of user experiences with the assets which allow the recommendation engine 115 to identify and suggest useful and effective resources. To reduce the transfer of data between LMS 120 and EADS 110, some context data may be persistently stored by the recommendation module 115, for example in dynamic metadata store 111b, for later use.

Once a user selects an asset for use, an access control module 119 included in the EADS 110 determines under which conditions the asset is available to the user. The access control module 119 can control which assets are indicated to the user as available for use (although such use may be contingent on purchase), and also actually providing assets for use by the user. Access control module 119 may provide location-based access to particular assets, granting access on the basis of an institution, department, of network address (e.g., IP address) affiliated with the user. Access control module 119 may provide context-based access to particular assets, granting access on the basis of, for example: course enrollment; membership in an organizations recognized by the LMS 120; and membership in study groups, teams, and research groups defined by the LMS 120. Access control module 119 may also exclude access to particular assets based on a role for a user reported by the LMS 120. For example, certain assets, such as exams, may be accessible to instructors but not students, as discussed in more detail below. Additionally, in most instances an asset provider wishes to be paid payment for use of assets, and may grant group licenses for the use of assets. Accordingly, the access control module 119 can verify that an asset is available to a user under a license such as an individual license (e.g., the user has previously paid for use of the asset), a group or department license, an institutional license, or a license for all users in a course or other learning context. Where it is determined that payment is required for use of the asset, access control module 119 cooperates with financial transaction module 117 to control access to the asset.

The financial transaction module 117, included in EADS 110, coordinates financial transactions between users seeking to purchase assets and asset providers. The financial transaction module provides infrastructure for handling such transactions, and may further provide aggregation of purchases for respective parties. Additionally, micropayment and subscription payments may be handled by the financial transaction module 117. Also, the EADS 110 is capable of completing transactions by, among other methods, using a credit card or a debit card managed by an educational institution. The financial transaction module can mediate a number of forms of transactions. For example, for credit card purchases it may interact with credit card processor 160 via a data network connection. In some instances, an asset provider system 140 may be capable of handling transactions for assets provided by the asset provider. In some embodiments, LMS 120 may provide access to a student debit card. Such debit cards are typically managed by an educational institution operating LMS 120, and provide students with a centralized mechanism for conducting and managing education-related expenses such as room and board, tuition, educational assets.

When a user purchases an asset, depending on the type or capabilities of the asset, various tasks may be performed by the EADS 110 and/or the LMS 120. Where an asset supports integration with a learning environment, it is installed on LMS 120 (if necessary) and becomes an integrated part of the user's access to the course materials. Other assets may be hosted on a remote asset provider system 140, storing assets in asset store 141, for example. A user might be provided access to such assets through a simple hyperlink, but with the benefit of user authentication being performed and negotiated by LMS 120 in order to facilitate access. Alternatively, the asset might be displayed within a frame within the user interface for LMS 120, to provide an integrated user experience. Additionally, such assets, even though hosted outside of the LMS 120 and EADS 110, may nevertheless provide student performance data back to the LMS 120 and/or the EADS 110, for better assessment of student and asset performance.

The EADS 110 supports the distribution of a broad range of assets, reflective of different content solutions which are being explored by content providers. New asset models are supported through subscription and micropayment payment mechanisms provided by the EADS 110. Additionally, new technologies have expanded the availability and use of supplementary assets such as simulations and games. The types of assets supported by the EADS 110 includes, but is not limited to: printed or printable materials, complete course packages, lesson plans, problem sets, interactive learning games, video presentations, audio presentations, and web-based tutoring.

The recommendation module 115 included in EADS 110 makes associations between the context in which a user on LMS 120 is operating and metadata stored for the assets being managed by the EADS 110. Among this stored metadata is metadata provided by an asset provider when submitting an asset to the EADS 110. Additionally, as the EADS 110 obtains context data during searches by users for desirable content, the EADS 110 accumulates context, navigation, and search data to develop a better understanding of various contexts which may be associated with a given asset. The frequency with which assets are considered and ultimately selected by users also helps identify relevant assets. When performing a search, the stored fixed metadata and dynamic metadata are cross-referenced against context data received from the LMS 120, which provides a context for candidate assets. Based on this context, the recommendation module 115 provides a targeted selection of assets which, based on correspondence between the context data provided by the LMS 120 and the metadata maintained by the EADS 110 in metadata store 111, is determined to be relevant to the user's context.

As noted in the previous paragraph, context data provided by LMS 120, which goes beyond the initial fixed metadata supplied by an asset provider to describe an asset, is stored by the EADS 110. Such context data includes, but is not limited to, the institution which the user is enrolled in, data identifying a course and characteristic of the course from which the user began browsing for available assets, all of the courses in which a user is enrolled in, and a role assigned to the user within the given context (e.g., the user may be a student in an advanced course, but also serving as an instructor for a lower-level course). This further data is used for future correlation of assets to received context data, which allows the system to make increasingly relevant suggestions in view of on the collective activities of various users who have searched for and selected various assets, rather than basing the correlation strictly upon the metadata registered in association with an asset by the asset provider.

Additional asset-related dynamic metadata may be received from users to further describe an asset. For example, instructors and students can review and rate assets, providing scoring for an asset, possibly for several categories such as comprehensiveness, ease of use, and benefits to learners, as well as textual comments describing opinions or experiences with the asset. This data may also be considered by the EADS 110 when identifying assets corresponding to a supplied user context. Additionally, such information may be displayed to a user as part of a detailed listing of an asset, to give the user a better understanding of the opinions of others regarding the asset, to allow a fuller assessment of the asset.

The above context matching for identifying relevant assets may include simple text-based searching for keywords in asset metadata as well, either as a tool for further filtering the results of context matching performed by the recommendation module 115, or as a starting point for a search for assets, particularly where a user accesses the EADS 110 via web server module 113 without context information available for a user accessing the EADS 110 via LMS 120.

Additionally, so long as the LMS 120 is properly registered with the EADS 110 user authentication performed by the LMS 120 may be accepted by the EADS 110, thereby facilitating access to the EADS 110 by eliminating the need for a user to perform separate authentication with the EADS 110. The user can perform a single login to the LMS 120, and access both the LMS 120 and the EADS 110 under the single login. Also, this facilitates increased integration with the LMS 120, whereby selection and purchases are made within the interface provided by the LMS 120, as illustrated below.

Not only may a user context be used to determine assets of particular value to a user, as discussed above, but the user context may also be used to restrict the availability of assets. For example, asset providers often produce large banks of questions relating to a given course of study, which are typically divided into different sets, such as student practice questions, supplemental practice questions, and exam questions. However, the EADS 110 denies students access to the exam questions, to allow instructors to reserve the questions for later exams. In contrast, users operating within an instructor context have access to the exam questions. Conventionally, distinguishing student and instructional users was performed manually. However, the ability to obtain context information from LMS 120, including roles for a user within the LMS 120, provides the EADS 110 with reliable information in this respect without the need for human intervention. Additionally, conventional asset distribution systems only assigned a single role to a user. For example, if a user was designated an instructor and granted access to instructional materials, such access applied to all assets. In contrast, the EADS 110 will successfully handle the situation where a single user serves two different roles within an institution (e.g., a student in a high-level course, but an instructor in a lower-level course), as the determination is made based on the user's current context, as indicated by the LMS 120.

Once purchased, an asset might reside or be installed in one of several locations. The asset can be hosted by an asset provider on a remote network accessible asset provider system 140, with use of the asset being directly provided by the asset provider. Alternatively, the asset might installed into the LMS 120 environment, offering an integrated solution. Also, the asset might be in the form of interactive computer software or multimedia to be installed directly on storage 141 of the user's PC 140. Further, some assets may simply be in the form of printed materials, either printable by the user, or physically delivered to the user, as in the case of conventional textbooks.

Assets can also be tailored to interoperate with performance measurement and assessment services provided by the LMS 120. Such services, if offered by the LMS 120, allow instructors and institutions to manage and monitor student progress based on the results associated with their use of such assets. Additionally, performance-related information, generally anonymized and aggregated, may be provided by the LMS 120, via the EADS 110, to an asset provider. In other embodiments, performance-related information collected by an asset provider in conjunction with use of an asset hosted by the asset provider may be provided to EADS 110 for improved assessment of assets. Such information is often useful in improving an asset.

In general, the EADS 110 operates to facilitate the connection between users with a particular educational need, characterized by the context in which the user is operating, and assets which address that need. Once that connection has been established, the EADS 110 further facilitates the purchase or such assets by users.

### Asset Provider Experience

For asset providers, a substantial benefit of the EADS 110 is the reduction in advertising costs and overhead. The EADS 110 makes it easier to reach relevant users, and achieve sales of smaller, more focused assets for which development and marketing was conventionally considered impractical.

Also, by shifting the financial transaction between an asset provider and student from the sale of a physical textbook to an electronic edition provided through the EADS 110, both parties to the transaction can realize benefits. Conventionally, the sale of used textbooks presents an issue for an asset provider, as only the first sale of a new asset realizes revenue for the asset provider. Thus, asset providers charge more for the single sale of the new asset. Sales of digital assets are able to avoid this issue, and the asset provider can realize the same or increased revenue, while offering a reduced price point to students. By way of example, under the conventional physical textbook model a book with a lifespan of 6 semesters might be purchased new for $100 (resulting in the only revenue obtained by the asset provider) and resold as a $50 used book for the following 5 semesters (with no corresponding revenue for the asset provider). However, through the EADS 110, assets needed for a course can be sold to each student each semester, at a reduced price. For example, if instead of the single $100 sale described above there are six $40 sales, the asset provider realizes a significant increase in revenue, while students obtain a reduction in course material costs, particularly for those who would have purchased the asset new, with the added benefit of having constantly updated materials. A wide range of alternative transaction models exist through the EADS 110. For example, there still may be a physical book component supplied by an asset provider, but with problem sets and interactive materials made available as digital assets via the EADS 110.

Regardless of which library model (repository or directory) the EADS 110 uses for assets, an asset provider will likely have to perform some degree of packaging to comply with EADS 110 requirements, either for providing metadata regarding the asset (such as information identifying the asset) or for use after purchase (such as information for accessing an asset stored on an asset provider's system). For assets that seek to directly integrate with the LMS 120, an asset will further have to conform with the interfaces provided by the LMS 120. As discussed previously, some assets may be even further integrated into the LMS 120 infrastructure, and provide performance metric data which convey the outcomes of student use of various assets. Outcomes data reflects the use and/or results of use of assets by students. Examples of outcomes data include, but are not limited to, scores on examinations and worksheets (or portions thereof), a simple indication that a particular asset has been accessed by a user, or milestones indicating student progress through a body of learning materials. Such outcomes data generally will be provided to the LMS 120 for use by a student, instructor, and/or institution. In some embodiments, such data may be provided back to the asset provider, via the EADS 110, for use by the asset provider to evaluate the use of their own assets. Typically the release of such information is controlled by the educational institution managing the respective LMS 120. Where an asset is instead hosted by the asset provider, the transfer of outcomes data may flow in the opposite direction, where asset provider system 140 performs its own analysis, and reports student results to the LMS 120 and/or EADS 110.

As discussed earlier, asset providers supply fixed metadata regarding each asset registered with the EADS 110. It is in the interest of asset providers to provide detailed metadata, as a more detailed description allows for better correlation between the asset and contexts in which the asset is most valued by users.

As a result of the ability to target particular user groups without a specific marketing campaign to reach that group, the sale of smaller assets is a more viable alternative. Thus, a more granular approach to assets may be adopted by some asset providers, in which large assets, such as textbooks spanning topics covering a semester or more, may be disaggregated and also made available as smaller assets on a topic-by-topic basis. From this arises additional opportunities to market these materials. For example, an instructor may wish to pick and choose various assets for assembling a course curriculum, and may choose a number of smaller topic-oriented assets from an asset provider, where otherwise none would have been selected at all. Thus, sales do not become an all-or-nothing event for asset providers.

For non-traditional, and typically smaller, asset providers such as new media companies (offering video and software assets, for example), institutions, and individual instructors, the EADS 110 offers a direct connection to a base of LMS users they conventionally did not have. This results is increased opportunities for both asset providers and students interested in such assets.

### Instructor Experience

For instructors, the EADS 110 provides a simpler and more effective means of creating a course plan and assets to be used to implement the course plan. Via the LMS 120, when an instructor is interested in setting up a new course, the instructor will create a course shell, providing the LMS 120 with information about the course being created. This information serves at least two functions with respect to the EADS 110. First, it provides an initial context used to locate potentially relevant course assets. Second, as an instructor searches for assets, or more importantly selects assets for use in the course, this information is recorded, in order to provide more relevant search results for future instructors or students seeking materials within a similar context.

As noted above, a finer granularity of materials is available from asset providers. For instructors who wish to assemble their own course curriculum on a topic-by-topic basis, the EADS 110 can provide targeted assets covering a wide range of topics, and make it easy to locate relevant materials. Also, in some instances an instructor may wish to mostly adopt a large prepackaged course plan, but make limited changes, such as using an alternative asset for a given topic, adding an additional topic, or removing topics. Integration between the LMS 120 and the EADS 110 makes it convenient for instructors to specify topics of interest and locate assets related to those topics.

Additionally, where a course plan and assets are appropriately tagged, the LMS 120 or EADS 110 can identify learning objectives or standards set forth in the course plan but not covered by the assets selected thus far for the course. The EADS 110 can then facilitate the search for assets corresponding to those learning objectives, in view of the context of the course, to help instructors rapidly assemble a course plan. As discussed above, such matching might be performed based on asset provider supplied fixed metadata, or dynamic metadata gathered from user activity on the EADS 110. Thus, EADS 110 easily allows instructors to satisfy the emerging demands for standards based education, by identifying assets that correspond to standards to which a course is directed, enabling selection of materials for students to purchase, enabling selection of materials for themselves to purchase, and/or enabling acquisition of licenses for everyone in the course.

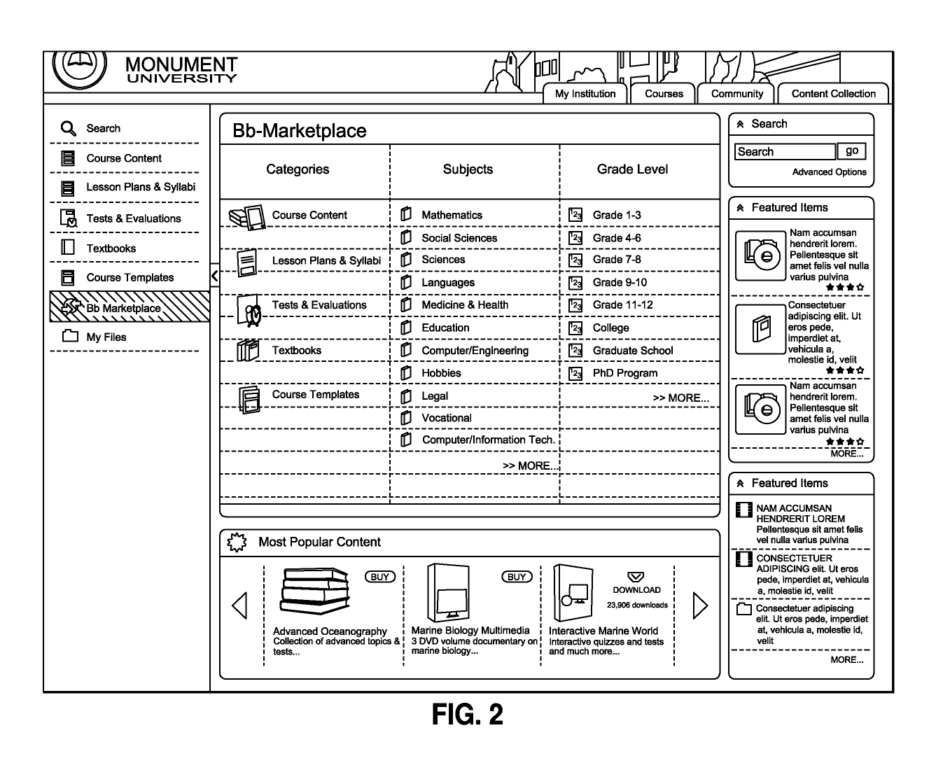

FIG. 2 is a screenshot of a learning management system (LMS) portal to EADS 110.

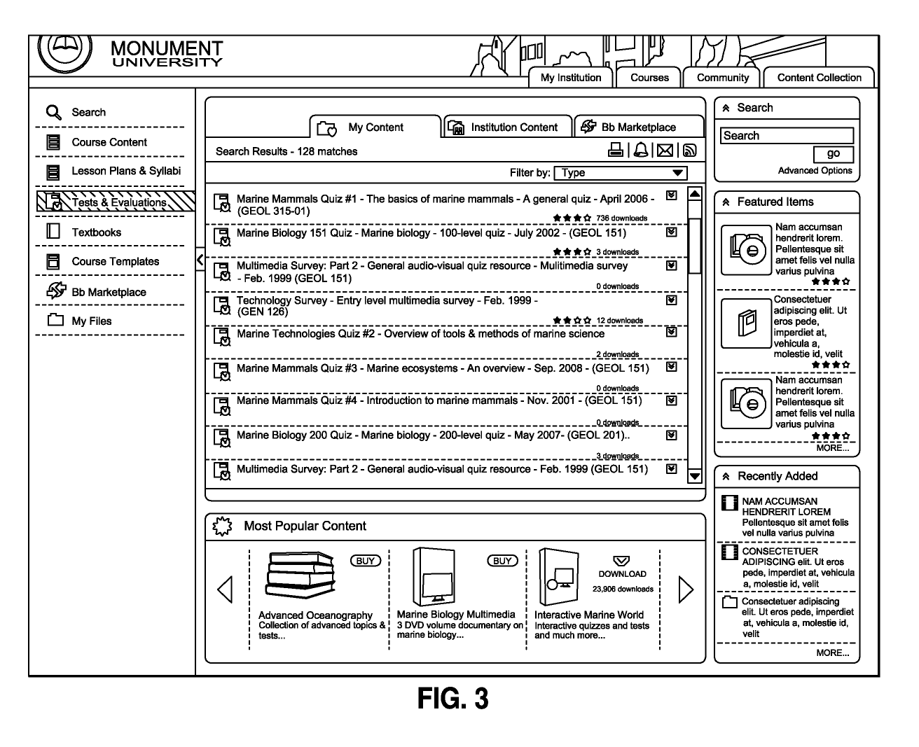

FIG. 3 is a screenshot of an LMS portal to EADS 110, displaying a user's personal asset collection

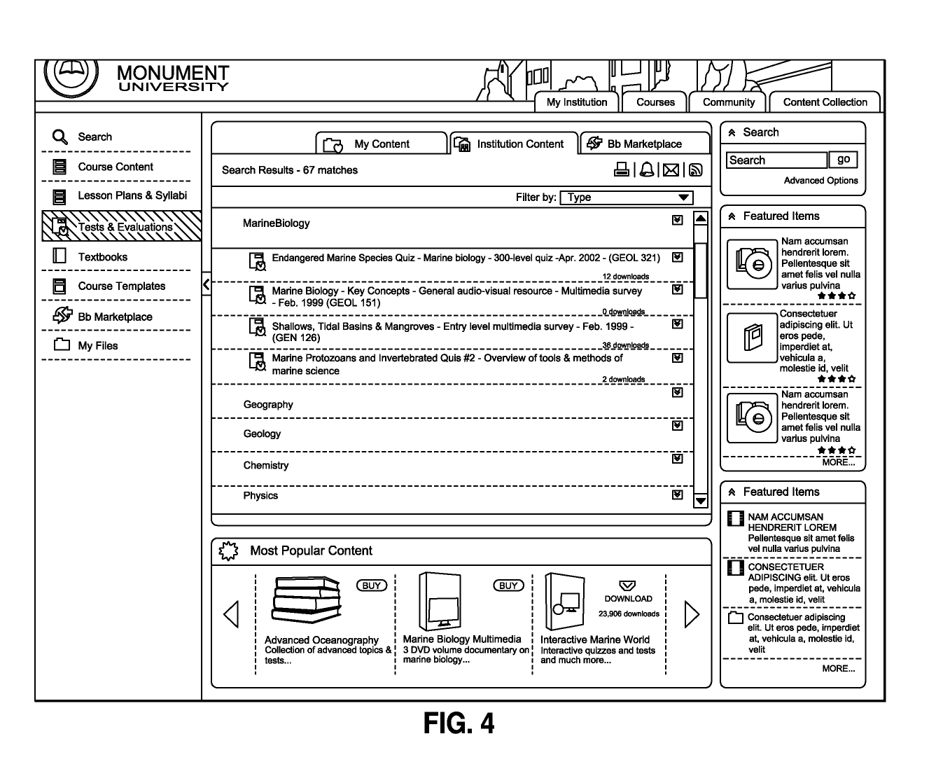

FIG. 4 is a screenshot of an LMS portal to EADS 110, displaying an institutional asset collection

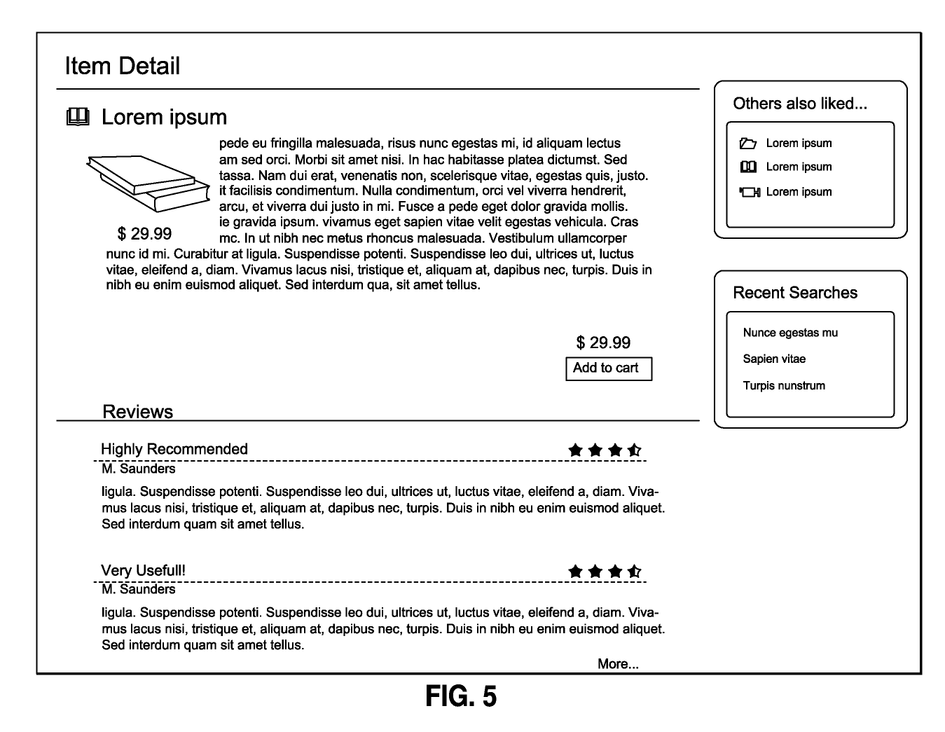

FIG. 5 is a screenshot of an LMS portal to EADS 110, displaying details of an asset, including user reviews. Instructors have the ability to review and rate assets to assist other instructors with future searches. Accordingly, instructors can actively participate as thought leaders by providing opinions on existing assets such as learning plans or learning materials. These opinions not only shape the decisions made by other instructors in selecting assets, but also aid asset providers in improving the quality of their assets. Instructors can also act as asset providers, and contribute their own assets for peer review and consumption. In conjunction with collaborative tools 170, such as community boards or asset specific forums, the EADS 110 provides an environment suitable not only for asset transaction, but also asset development, asset collaboration, and peer review activities.

As noted above, feedback provided by way of outcomes data for the use of assets allows instructors to assess student performance as well as gauge the success of assets for teaching a particular course, subject, or objective.

### Student Experience

For most students, the initial experience with the EADS 110 will be purchasing assets that have been pre-selected by an instructor for a class in which the student is enrolled. Upon first using the LMS 120 for a course, a student can immediately purchase assets designated by the instructor. These assets include the assets needed for the course, such as textbook equivalent assets, but the instructor may also suggest certain optional supplemental materials that, in the instructor's experience, may be helpful for students. As discussed above, the financial transaction module 117 handles the financial transactions associated with purchasing the assets by, for example, handling credit card payments. Additionally, students may access materials already licensed by their instructor or institution.

Beyond this initial experience, students may wish to locate supplemental materials particularly directed to topics that the student is currently working on, but having difficulty with. By initiating a search for assets from within the LMS 120, a context is available to the EADS 110 which enables the recommendation module 115 to provide an initial focused listing of possible supplemental materials, targeted to the student's current needs. Presented with assets by the EADS 110 in this manner, students are able to take control of their own educational experience, and establish a direct relationship with asset providers. Thus, the EADS 110 provides substantial value by not only providing access to a wide range of useful materials, but in a targeted manner that enables students to quickly make connections with useful assets provided by various asset providers.

Additionally, students have the ability to review and rate assets, to assist other students in evaluating assets. Student reviews and ratings are separate from the instructor reviews and ratings discussed previously, as the two communities generally have different needs and considerations with respect to educational assets. For example, instructors may have interest in how assets address standards-based education, whereas students are unlikely to find such information useful. Accordingly, based on a user role provided in context information provided by LMS 120, different review information an options will be presented to a user.

Further, the LMS 120 can proactively identify when supplemental assets may help students deal with challenging subject matter, and offer specific recommendations to students, presented within the student's ordinary usage of LMS 120. Determining when a student may be facing challenging subject matter may be based on individual outcome data or grades (where the student has authorized the consideration of such data for this purpose). Additionally, as students begin preparing for scheduled exams is likely to be a time when students will have an interest in supplemental assets such as practice exams. Where the EADS 110 is provided with exam and quiz information, such as scheduling and content, recommendation module 115 can automatically offer recommendations for presentation with course information in LMS 120. Students may also have an interface to input contextual information to build metadata and help the system make recommendations. Further, there may be a survey feature to collect relevant data about a student's experience and background.

As suggested above, actual student outcomes data, where exposing such data has been permitted by the student, is valuable in demonstrating the effectiveness. Such data is most likely reviewed by an instructor or an asset provider, but the EADS 110 may consider outcomes, where available, to identify relevant and effective assets.

Assets that specifically exploit the opportunities for integration with LMS 120 offer a more consistent experience for students. Such assets, when obtained by a student, integrate themselves into, and expand upon, the existing course plan provided by an instructor. For example, additional practice problems may be incorporated on a lecture-by-lecture basis, providing a student with greater opportunity to practice new concepts.

### Institutional Experience

Generally, it is an educational institution which is responsible for setting up and maintaining the LMS 120 for its students. This includes determining the scope of metadata that may be shared with the EADS 110. The LMS 120 may also be able to provide and receive data reflective of the outcomes obtained by students in interacting with assets. This primarily depends upon the asset being either sufficiently tagged or specifically designed to interface with the mechanisms provided by the LMS 120. This outcomes information can be collected and provided to: a student, to better understand her progress; an instructor, to measure the process of students; an institution, to observe the effectiveness of various classes, programs, and assets; and the EADS 110, to provide further data to quantify the quality of various assets.

Copyright clearance is increasingly a concern for institutions. This issue is mitigated by the use of the EADS 110 for obtaining course assets. Through the ease of use of the EADS 110, instructors and students can choose from a wide variety of copyright cleared assets, and have a mechanism for paying for those assets. Fixed metadata provided by asset providers can also indicate various terms and limitations for use of copyrighted works, which may be enforced by LMS 120. For example, an asset may be accessible only while a user is enrolled in a specific course.

Also, in many cases curriculum decisions and purchases may be made at an institutional level, and many institutions purchase assets on behalf of students. The EADS 110 serves as a subscription and procurement management vehicle for such institutions. The EADS 110 can be provided data that a user is an institutional volume purchaser, and enable discounted purchases.

### Hardware

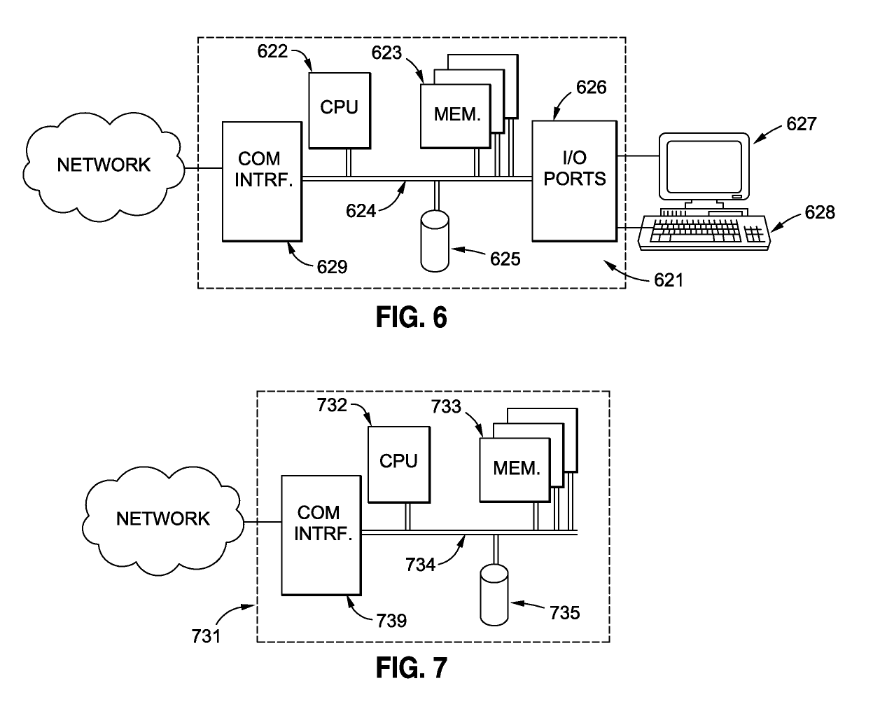

FIG. 6 is a functional block diagram of a PC based implementation of computer system 621, which may serve, for example, as a user PC. The exemplary system 621 contains a central processing unit (CPU) 622, memories 623 and an interconnect bus 624. The CPU 622 may contain a single microprocessor (e.g. an x86 microprocessor), or it may contain a plurality of microprocessors for configuring the computer system 621 as a multi-processor system. The memories 623 include a main memory, such as a dynamic random access memory (DRAM), as well as a read only memory, such as a PROM, an EPROM, a FLASH-EPROM, or the like. The system 621 also includes mass storage devices such as various disk drives, tape drives, etc. The main memory typically includes dynamic random access memory (DRAM) and high-speed cache memory. In operation, the main memory stores at least portions of instructions and data for execution by the CPU 622.

The mass storage may include one or more magnetic disk or tape drives or optical disk drives, for storing data and instructions for use by CPU 622. For a user PC, for example, at least one mass storage system 625 in the form of a disk drive or tape drive, stores the operating system and application software as well as data, such as received messages and documents. The mass storage 625 within the computer system 621 may also include one or more drives for various portable media, such as a floppy disk, a compact disc read only memory (CD-ROM), or an integrated circuit non-volatile memory adapter (i.e. PC-MCIA adapter) to input and output data and code to and from the computer system 621.

The system 621 also includes one or more input/output interfaces for communications, shown by way of example as an interface 629 for data communications via the network. The interface 629 may be a modem, an Ethernet card or any other appropriate data communications device, for digital communications of various types via a network. The physical communication links may be optical, wired, or wireless (e.g., via satellite, cellular, or WLAN network).

The computer system 621 may further include appropriate input/output ports 126 for interconnection with a display 627 and a keyboard 628 serving as the respective user interface. For example, the computer may include a graphics subsystem to drive the output display 627. The output display 627 may include a cathode ray tube (CRT) display or liquid crystal display (LCD). The input control devices for such an implementation of the system 621 would include the keyboard 628 for inputting alphanumeric and other key information. The input control devices for the system may further include a cursor control device (not shown), such as a mouse, a trackball, stylus, or cursor direction keys. The links of the peripherals 627, 628 to the system 621 may be wired connections or use wireless communications.

Each computer system 621 runs a variety of applications programs and stores data, enabling one or more interactions via the user interface, provided through elements such as 627 and 628, and/or over the network to implement the desired processing for the inventory service or the processing of requests for inventory services.

FIG. 7 is a functional block diagram of a general-purpose computer system 731, which may perform the functions of a server including the EADS 110, LMS 120, and asset provider systems 140 and 150.

The exemplary computer system 731 contains a central processing unit (CPU) 732, memories 733 and an interconnect bus 734. The CPU 132 may contain a single microprocessor, or may contain a plurality of microprocessors for configuring the computer system 732 as a multi-processor system. Although not illustrated as such, computer system 731 may comprise a plurality of discrete computer systems, interconnected via a data network. The memories 733 include a main memory, a read only memory, and mass storage devices such as various disk drives, tape drives, etc. The main memory typically includes dynamic random access memory (DRAM) and high-speed cache memory. In operation, the main memory stores at least portions of instructions and data for execution by the CPU 732.

The mass storage may include one or more magnetic disk or tape drives or optical disk drives, for storing data and instructions for use by CPU 732. At least one mass storage system 735, preferably in the form of a disk drive or tape drive, stores the database used for the inventory service. The mass storage 735 may also include one or more drives for various portable media, such as a floppy disk, a compact disc read only memory (CD-ROM), or an integrated circuit non-volatile memory adapter (e.g., a PC-MCIA or USB adapter) to input and output data and code to and from the computer system 731.

The system 731 also includes one or more input/output interfaces for communications, shown by way of example as an interface 739 for data communications via a network. The interface 739 may be a modem, an Ethernet card or any other appropriate data communications device. To provide the inventory service to a large number of users, the interface 739 preferably provides a relatively high-speed link to the network The physical communication link may be optical, wired, or wireless (e.g., via satellite, cellular, or WLAN network). Alternatively, the computer system may comprise a mainframe or other type of host computer system.

Although not shown, the system 731 may further include appropriate input/output ports for interconnection with a local display and a keyboard or the like serving as a local user interface. Alternatively, the server operations personnel may interact with the system 731 for control and programming of the system from remote terminal devices via the network link.

The computer system 731 runs a variety of applications programs and stores the database. Those skilled in the art will recognize that the computer system 731 may run other programs and/or host other database services. As such, the system 731 need not sit idle while waiting for inventory service related functions. Also, the system 731 may be implemented as a single computer system or as a distributed system having multiple appearances at different nodes on the network.

The components contained in the computer systems 721 and 731 are those typically found in general purpose computer systems used as servers, workstations, personal computers, network terminals, and the like. In fact, these components are intended to represent a broad category of such computer components that are well known in the art.

Certain aspects of the invention relate to the software elements, such as the executable code and/or database software used to implement the inventory functions. These functions may reside on different physical systems, linked by local or wide area communications networks.

At different times all or portions of the executable code or database for any or all of these software elements may reside in storage media or be carried by electromagnetic media. The various data components as well as other files relating to the inventory system developed may reside in or be transported via a variety of different media. Physical media include the memory of the computer processing systems 621, 731, such as various semiconductor memories, tape drives, disc drives and the like of general-purpose computer systems. All or portions of the software may at times be communicated through via a network or various other telecommunication networks. Such communications, for example, may be to load the software from another computer (not shown) into a server or into another network element. Thus, another type of media that may bear the software elements includes optical, electrical and electromagnetic waves, such as used across physical interfaces between local devices, through wired and optical landline networks and over various air-links.

Hence, operations described above may be carried out by execution of software, firmware, or microcode operating on a router or computer of any type. Additionally, code for implementing such operations may be in the form of computer instruction in any form (e.g., source code, object code, interpreted code, etc.) stored in or carried by any computer or machine readable medium.

At different times all or portions of the executable code for any or all of these programming elements may reside in storage media or be carried by electromagnetic media. Storage media include the memory of the wireless controller or of memory or other storage elements of computer processing systems that may supply programming to the wireless controller, such as various semiconductor memories, tape drives, disc drives and the like. All or portions of the software may at times be communicated through the Internet or various other telecommunication networks. Such communications, for example, may be to load the software or an update thereof from a computer (not shown) into the wireless controller. Thus, another type of media that may bear the software elements includes optical, electrical and electromagnetic waves, such as used across physical interfaces between local devices, through wired and optical landline networks and over various air-links.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An educational asset distribution system, comprising:
an asset registration module which obtains information about a plurality of educational assets, said information including fixed metadata descriptive of an educational asset, and information for accessing the educational asset;
a learning management system interface which receives context data descriptive of a user of a learning management system;
a dynamic metadata storage which stores a portion of the context data in association with the fixed metadata; and
an educational assets management module for managing the plurality of educational assets based on the context data, the information about the plurality of educational assets, and data stored in the dynamic metadata storage.

2. The educational asset distribution system of claim 1, wherein
the educational assets management module comprises a recommender module which selects a plurality of recommended assets based on the context data, the information about the plurality of educational assets, and data stored in the dynamic metadata storage.

3. The educational asset distribution system of claim 1, wherein
the educational assets management module comprises a licensing module which determines purchasing options for assets based on the context data, the information about the plurality of educational assets, and data stored in the dynamic metadata storage.

4. The educational asset distribution system of claim 1, wherein
the educational assets management module comprises an access control module which controls the availability of educational assets to the user based on the context data, the information about the plurality of educational assets, and data stored in the dynamic metadata storage

5. The educational asset distribution system of claim 1, wherein
the context data describes a course associated with the user.

6. The educational asset distribution system of claim 1, wherein
the management performed by the educational assets management module is further based on outcomes of the user's use of educational materials on the learning management system.

7. The educational asset distribution system of claim 1, further comprising
an asset store for storing educational assets for which information has been obtained by the asset registration module; and
a provider interface module which receives from a remote system a submitted educational asset for storage by the asset store, and metadata descriptive of the submitted education asset for the asset registration module.

8. The educational asset distribution system of claim 1, further comprising
a provider interface module which receives a submitted educational asset for storage by the asset store, metadata descriptive of the submitted education asset for the asset registration module, and information for accessing the educational asset from a remote system, wherein
the learning management system interface provide information to the learning management system for accessing the submitted educational asset from the remote system.

9. The educational asset distribution system of claim 1, wherein
the learning management system interface receives a plurality of context data for a plurality of users of a plurality of learning management systems,
the dynamic metadata storage stores a portion of each of the plurality of context data, and
the educational assets management module manages the plurality of educational assets based on the plurality of context data.

10. The educational asset distribution system of claim 1, wherein
authentication of the user is performed by the learning management system and received via the learning management system interface.

11. The educational asset distribution system of claim 1, wherein
authorization of the user is performed by the learning management system and received via the learning management system interface.

12. The educational asset distribution system of claim 1, wherein
the context data includes role data indicating if the user is an instructor or a student in a context; and
in response to the role data indicating the user is a student, the educational assets management module does not operate on an instructor-oriented asset.

13. The educational asset distribution system of claim 1, wherein
a request for additional context data is initiated by the educational assets management module and submitted to the learning management system via the learning management system interface.

14. The educational asset distribution system of claim 1, wherein
the dynamic metadata storage stores search data for searches performed via the educational asset distribution system, and
the educational assets management module manages the plurality of educational assets based on the search data.

15. The educational asset distribution system of claim 1, wherein
the dynamic metadata storage stores purchase data regarding purchases made by users via the educational asset distribution system, and
the educational assets management module manages the plurality of educational assets based on the purchase data.

16. The educational asset distribution system of claim 1, wherein
the dynamic metadata storage stores user ratings of assets and tagging/categorization metadata, each submitted via the learning management system interface, and
the educational assets management module manages the plurality of educational assets based on the user ratings of assets and tagging/categorization metadata.

17. The educational asset distribution system of claim 1, wherein
the educational assets management module is responsive to membership of the user within a particular group of users.

18. The educational asset distribution system of claim 1, wherein
the educational assets management module is responsive to role data indicating a role the user serves a context.

19. The educational asset distribution system of claim 15, wherein
the access control module is responsive to role data indicating multiple roles the user serves in a plurality of groups.

20. The educational asset distribution system of claim 2, further comprising
a financial transaction module which processes a purchase of a desired educational asset by the user; and
an access control module which controls availability of the desired educational asset to the user in response to the financial transaction module.

21. The educational asset distribution system of claim 1, wherein
the context data includes a course plan and assets selected for the course plan, and the educational assets management module manages additional assets in response to objectives or standards included in the course plan.

22. The educational asset distribution system of claim 1, wherein
the context data includes a course plan and assets selected for the course plan, and the educational assets management module manages additional assets in response to the assets selected for the course plan.

23. The educational asset distribution system of claim 16, wherein
user ratings of assets are associated with role data indicating if a user is an instructor or a student in a context; and
user ratings information is provided to a user of the leaning management system in response to role data for the user of the leaning management system.

24. The educational asset distribution system of claim 1, wherein
the dynamic metadata storage stores outcomes of the use of the plurality of users of an educational asset; and
the educational assets management module manages the plurality of educational assets based on the outcomes of the use of the plurality of users of the educational asset.
